(19) United States
(12) Patent Application Publication
(10) Pub. No.: US 2025/0117933 A1
(43) Pub. Date: Apr. 10, 2025

(54) MEDICAL INFORMATION PROCESSING APPARATUS AND COMPUTER-READABLE STORAGE MEDIUM

(71) Applicants: CANON MEDICAL SYSTEMS CORPORATION, Tochigi (JP); THE BRIGHAM AND WOMEN’S HOSPITAL, INC., Boston, MA (US)

(72) Inventors: Mami TAKAHASHI, Nasushiobara (JP); Tomoki FUJITO, Nasushiobara (JP); Kohei WATANABE, Utsunomiya (JP); Yasuko FUJISAWA, Nasushiobara (JP); David R. WALT, Boston, MA (US)

(73) Assignees: CANON MEDICAL SYSTEMS CORPORATION, Tochigi (JP); THE BRIGHAM AND WOMEN’S HOSPITAL, INC., Boston, MA (US)

(21) Appl. No.: 18/911,571

(22) Filed: Oct. 10, 2024

Related U.S. Application Data
(60) Provisional application No. 63/589,082, filed on Oct. 10, 2023.

(51) Int. Cl. G06T 7/00; G06T 7/11

(52) U.S. Cl. CPC G06T 7/0012; G06T 7/11

(57) ABSTRACT

A medical information processing apparatus according to an embodiment includes processing circuitry configured to acquire a medical image obtained by imaging a subject, acquire a value of a biomarker contained in a sample collected from the subject, determine a region of interest on the acquired medical image, analyze the image of the determined region of interest and calculate a property of a drawn object, select a value of a biomarker associated with the calculated property of the drawn object, and determine consistency between the selected value of the biomarker and the calculated property of the drawn object.

### CROSS REFERENCE TO RELATED APPLICATIONS

This application is based upon and claims the benefit of priority from the prior U.S. Provisional Patent Application No. 63/589,082, filed on Oct. 10, 2023, the entire contents of which are incorporated herein by reference.

### FIELD

Embodiments disclosed in the present specification and the drawings relate to a medical information processing apparatus and a computer-readable storage medium.

### BACKGROUND

In the related art, a liquid biopsy that performs a lesion diagnose and the like using a body fluid such as blood is known as an examination with a low burden on a subject such as a patient.

### BRIEF DESCRIPTION OF THE DRAWINGS

FIG. 1 is a block diagram illustrating a configuration example of a medical information processing system according to a first embodiment;

FIG. 2 is a block diagram illustrating a configuration example of a medical information processing apparatus according to the first embodiment;

FIG. 3 is a flowchart illustrating an operation example of the medical information processing apparatus according to the first embodiment;

FIG. 4 is a view illustrating an example of a value of a biomarker in the operation example of the medical information processing apparatus according to the first embodiment;

FIG. 5 is a view illustrating a correspondence relationship between a type of cancer and a mammography image finding in the operation example of the medical information processing apparatus according to the first embodiment;

FIG. 6 is a view illustrating an example of a value of a determination table used for determining consistency in the operation example of the medical information processing apparatus according to the first embodiment;

FIG. 7 is a flowchart illustrating a detailed operation example of the medical information processing apparatus according to the first embodiment;

FIG. 8 is a view illustrating a mammography image and a region of interest in the operation example of the medical information processing apparatus according to the first embodiment;

FIG. 9 is a flowchart illustrating an operation example of a medical information processing apparatus according to a first modification of the first embodiment;

FIG. 10 is a flowchart illustrating an operation example of a medical information processing apparatus according to a second modification of the first embodiment;

FIG. 11 is a block diagram illustrating a configuration of a medical information processing apparatus according to a third modification of the first embodiment;

FIG. 12 is a flowchart illustrating an operation of the medical information processing apparatus according to the third modification of the first embodiment;

FIG. 13 is a flowchart illustrating an operation example of a medical information processing apparatus according to a second embodiment;

FIG. 14 is a view illustrating a mammography image before a biopsy and a mammography image after a biopsy in the operation example of the medical information processing apparatus according to the second embodiment;

FIG. 15 is a flowchart illustrating an operation of a medical information processing apparatus according to a modification of the second embodiment; and

FIG. 16 is a view illustrating the operation of the medical information processing apparatus according to the modification of the second embodiment.

### DETAILED DESCRIPTION

Hereinafter, embodiments of a medical information processing apparatus will be described with reference to the drawings. Note that, in the following description, components having substantially the same functions and configurations are denoted by the same reference numerals, and redundant description will be given only when necessary.

### First Embodiment

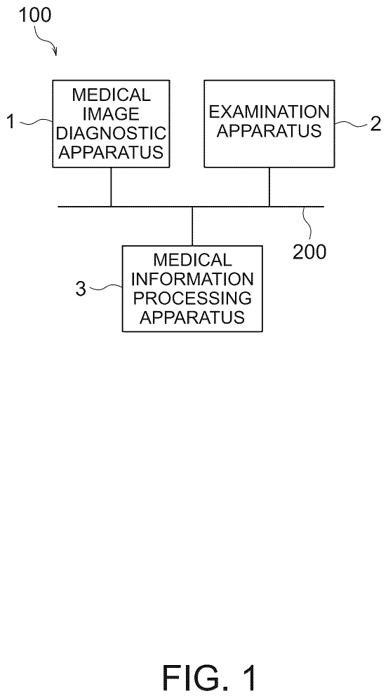

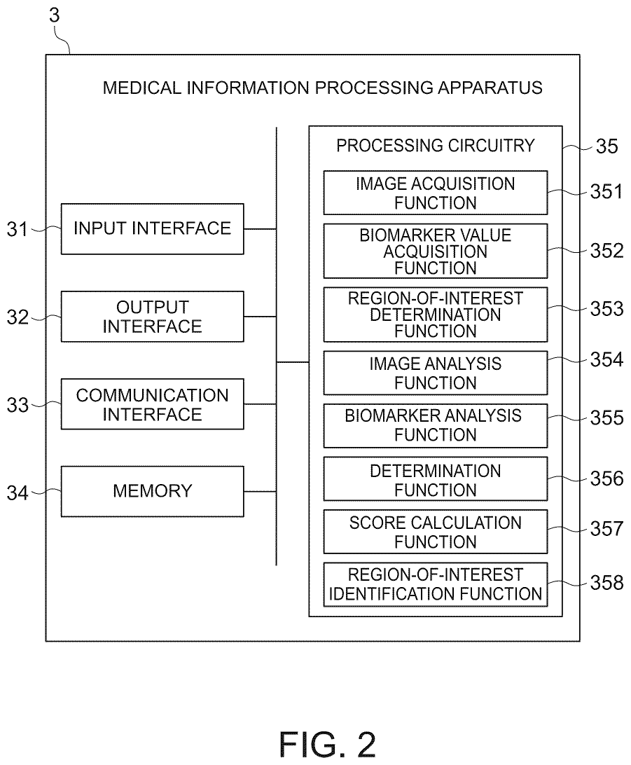

FIG. 1 is a block diagram illustrating a configuration example of a medical information processing system 100 according to a first embodiment. FIG. 2 is a block diagram illustrating a configuration example of a medical information processing apparatus 3 according to the first embodiment.

As illustrated in FIG. 1, the medical information processing system 100 according to the first embodiment includes a medical image diagnostic apparatus 1, an examination apparatus 2, and a medical information processing apparatus 3. The medical image diagnostic apparatus 1, the examination apparatus 2, and the medical information processing apparatus 3 are communicably connected via a network 200. That is, the medical information processing apparatus 3 is provided on the medical information processing system 100 connected via the network 200. Note that the medical information processing apparatus 3 may be an offline apparatus. In this case, the medical information processing apparatus 3 may acquire information from the medical image diagnostic apparatus 1 and the examination apparatus 2 via a portable recording medium.

The respective apparatuses included in the medical information processing system 100 may be in a state of being able to communicate with each other directly or indirectly by, for example, an in-hospital local area network (LAN) installed in a hospital. In addition, an apparatus (for example, a server or the like that stores medical information) other than those illustrated in FIG. 1 may be communicably connected to the medical information processing system 100 illustrated in FIG. 1.

For example, the medical information processing system 100 may include various systems such as an electronic health record (EHR) system, a picture archiving and communication system (PACS), a hospital information system (HIS), a radiology information system (RIS), and a laboratory information system (LIS).

The medical image diagnostic apparatus 1 images a subject and collects a medical image. Then, the medical image diagnostic apparatus 1 transmits the collected medical image to the medical information processing apparatus 3. For example, the medical image diagnostic apparatus 1 may be an X-ray diagnostic apparatus such as a mammography apparatus, an X-ray computed tomography (CT) apparatus, a magnetic resonance imaging (MRI) apparatus, an ultrasonic diagnostic apparatus, a single photon emission computed tomography (SPECT) apparatus, a positron emission computed tomography (PET) apparatus, or the like. The medical image is, without limitation, typically a structural image that visualize structural features within the body of the subject. In this sense, the medical imaging system 1 is typically an X-ray diagnostic system, an X-ray CT apparatus, an MRI apparatus, an ultrasonic diagnostic apparatus, or the like.

The examination apparatus 2 is operated by a clinical laboratory technician or the like, and executes a specimen examination for analyzing a specimen (that is, a sample) such as blood or urine acquired from a patient. The specimen examination is, for example, a pathological examination, a blood/biochemical examination, a liquid biopsy examination, a general examination of urine, feces, or the like, an immune serum examination, a genetic examination, a microorganism examination, a blood transfusion or organ transplant-related examination, or the like. Then, the examination apparatus 2 transmits an examination result (measurement data or the like) of the specimen examination to the medical information processing apparatus 3.

For example, the examination apparatus 2 may be a biochemical automatic analysis apparatus, an immune automatic analysis apparatus, a flow cytometer, a gene analysis apparatus, a protein analysis apparatus, an extracellular vesicle analysis apparatus, a circulating tumor cell detection apparatus, or the like. Note that the flow cytometer is a device that performs flow cytometry. Flow cytometry is an analysis method in which a suspension of an object to be measured is used as a high-speed fluid, scattered light and fluorescence generated by irradiating the fluid with laser light, mercury light, or the like are measured, and the size, amount, or the like of the object to be measured is measured.

The gene analysis apparatus is an apparatus for analyzing a gene sequence. For example, the gene analysis apparatus is an apparatus that amplifies a nucleic acid molecule extracted from a biological sample by a polymerase chain reaction (PCR) method or the like and performs determination of the presence or absence of a specific gene sequence and quantitative determination, or an apparatus that analyzes sequence information of a nucleic acid molecule. The protein analysis apparatus is, for example, an automatic immunoassay analysis apparatus, a highly sensitive protein detection apparatus (for example, Single Molecule Assay Apparatus SIMOA (registered trademark), manufactured by Quanterix Inc.), or the like.

In addition, the extracellular vesicle analysis apparatus is, for example, a single extracellular vesicle analysis apparatus (for example, EXOVIEW (registered trademark), manufactured by NanoView Biosciences, Inc.), or the like. In addition, the circulating tumor cell detection apparatus is, for example, a circulating tumor cell detection apparatus (for example, CELLSEARCH (registered trademark) system, manufactured by Veridex, LLC), or the like.

The medical information processing apparatus 3 acquires various types of information from the medical image diagnostic apparatus 1 and the examination apparatus 2, and performs various types of information processing using the acquired information. For example, the medical information processing apparatus 3 is realized by computer equipment such as a server, a workstation, a personal computer, or a tablet terminal.

As illustrated in FIG. 2, the medical information processing apparatus 3 includes an input interface 31, an output interface 32, a communication interface 33, a memory 34, and a processing circuitry 35. The input interface 31, the output interface 32, the communication interface 33, and the memory 34 are connected to the processing circuitry 35.

The input interface 31 receives various instructions and information input operations from an operator. Specifically, the input interface 31 converts an input operation received from the operator into an electrical signal and outputs the electrical signal to the processing circuitry 35. For example, the input interface 31 is realized by a trackball, a switch button, a mouse, a keyboard, a touch pad that performs an input operation by touching an operation surface, a touch screen in which a display screen and a touch pad are integrated, a non-contact input circuit using an optical sensor, a sound input circuit, or the like. Note that the input interface 31 is not limited to one including physical operation components such as a mouse and a keyboard. For example, an electric signal processing circuit that receives an electric signal corresponding to an input operation from an external input device provided separately from the apparatus and outputs the electric signal to the processing circuitry 35 is also included in the example of the input interface 31.

The output interface 32 outputs various types of information. For example, the output interface 32 includes a display. The display outputs a graphical user interface (GUI) or the like for receiving the medical image generated by the processing circuitry 35 and various operations from the operator. For example, a liquid crystal display (LCD), a cathode ray tube (CRT) display, an organic electroluminescence display (OELD), a plasma display, or any other display can be appropriately used as the display. The output interface 32 may include a speaker.

The communication interface 33 controls communication performed with each apparatus in the medical information processing system 100. Specifically, the communication interface 33 receives various types of information from each apparatus, and outputs the received information to the processing circuitry 35. For example, the communication interface 33 is realized by a network card, a network adapter, a network interface controller (NIC), or the like.

The memory 34 is a non-transitory storage device that stores various types of information, and is, for example, a hard disk drive (HDD), an optical disk, a solid state drive (SSD), an integrated circuit storage device, or the like. The memory 34 stores, for example, a control program for controlling the medical information processing apparatus 3 and various types of data used for executing the control program. The memory 34 may be a drive device that reads and writes various types of information from and to a portable storage medium such as a compact disc (CD), a digital versatile disc (DVD), or a flash memory, a semiconductor memory element such as a random access memory (RAM), or the like, in addition to the HDD, the SSD, and the like.

The processing circuitry 35 is a circuit that controls the entire operation of the medical information processing apparatus 3 according to an electric signal of an input operation input from the input interface 31. For example, the processing circuitry 35 has an image acquisition function 351, a biomarker value acquisition function 352, a region-of-interest determination function 353, an image analysis function 354, a biomarker analysis function 355, a determination function 356, a score calculation function 357, and a region-of-interest identification function 358.

Here, for example, each processing function executed by each of the image acquisition function 351, the biomarker value acquisition function 352, the region-of-interest determination function 353, the image analysis function 354, the biomarker analysis function 355, the determination function 356, the score calculation function 357, and the region-of-interest identification function 358, which are the components of the processing circuitry 35 illustrated in FIG. 2, is recorded in the memory 34 in the form of a computer-executable program. The processing circuitry 35 is, for example, a processor. The processor constituting the processing circuitry 35 reads each program from the memory 34 and executes the program to realize a function corresponding to each read program. In other words, the processing circuitry 35 in a state of reading each program has each function illustrated in the processing circuitry 35 of FIG. 2.

Note that, in FIG. 2, although a case where a processing function of each of the image acquisition function 351, the biomarker value acquisition function 352, the region-of-interest determination function 353, the image analysis function 354, the biomarker analysis function 355, the determination function 356, the score calculation function 357, and the region-of-interest identification function 358 is realized by a single processing circuitry 35 is described, an embodiment is not limited thereto. For example, the processing circuitry 35 may be configured by combining a plurality of independent processors, and each processor may execute each program to realize each processing function. In addition, each processing function of the processing circuitry 35 may be realized by being appropriately distributed or integrated into a single or a plurality of processing circuits.

The image acquisition function 351 acquires a medical image obtained by imaging a subject. For example, the image acquisition function 351 acquires a medical image acquired by imaging a subject by the medical image diagnostic apparatus 1 from the medical image diagnostic apparatus 1 via the network 200. The medical image is received from the medical image diagnostic apparatus 1 by the communication interface 33 and stored in the memory 34, and then read and acquired from the memory 34 by the image acquisition function 351.

The biomarker value acquisition function 352 acquires a value of a biomarker contained in a sample collected from a subject. For example, the biomarker value acquisition function 352 acquires the value of the biomarker acquired by examining a subject by the examination apparatus 2 from the examination apparatus 2 via the network 200. The sample collected from the subject is, for example, a body fluid of the subject such as blood or urine. The biomarker value acquisition function 352 acquires a value of a biomarker associated with a lesion such as cancer that is potentially present in a subject.

The region-of-interest determination function 353 determines a region of interest (ROI) on the medical image acquired by the image acquisition function 351. The region of interest is determined, for example, as a region suspected of the presence of a lesion on the medical image. For example, the region-of-interest determination function 353 determines a region of interest based on machine learning. That is, the region-of-interest determination function 353 determines a region of interest based on a learned model obtained by learning a lesion on the medical image. Note that, in a case where the information indicating the region of interest set by the medical image diagnostic apparatus 1 is acquired by the medical information processing apparatus 3, the region-of-interest determination function 353 may determine the region of interest based on the information indicating the region of interest. The region-of-interest determination function 353 can determine a plurality of regions of interest on the medical image acquired by the image acquisition function 351. The region-of-interest determination function 353 may determine the region of interest in a case where the value of the biomarker acquired by the biomarker value acquisition function 352 is a value indicating a possibility that a lesion is present in the subject.

The image analysis function 354 analyzes the image of the region of interest determined by the region-of-interest determination function 353, and calculates (that is, detects) the property of the drawn object within the region of interest. The image analysis function 354 calculates the property of the drawn object according to a type of the lesion. For example, as a result of analyzing the image of the region of interest, the image analysis function 354 may calculate that an edge of the drawn object (that is, the tumor) is smooth as the property of the drawn object corresponding to the triple negative breast cancer. In addition, as a result of analyzing the image of the region of interest, the image analysis function 354 may calculate that the drawn object is irregularly shaped or has spicules or the like, as the property of the drawn object corresponding to luminal A breast cancer. In addition, as a result of analyzing the image of the region of interest, the image analysis function 354 may calculate that the drawn object is accompanied by pleomorphic, fine linear, or branched calcification, as one of the properties of the drawn object corresponding to HER2-positive breast cancer. The image analysis function 354 may calculate the property of the drawn object using, for example, a learned model obtained by learning the image recognition and the property of the drawn object.

The biomarker analysis function 355 selects a value of a biomarker associated with the property of the drawn object calculated by the image analysis function 354. For example, the biomarker analysis function 355 selects values of types of biomarkers associated with the property of the drawn object calculated by the image analysis function 354 from among the values of the plurality of types of biomarkers acquired by the biomarker value acquisition function 352. The value of the biomarker selected by the biomarker analysis function 355 is not limited to one type, and a plurality of types may be present.

For example, in a case where the property of the drawn object calculated by the image analysis function 354 is that the edge of the drawn object is smooth, the biomarker analysis function 355 selects a value of a biomarker associated with triple negative breast cancer from among the values of the biomarker acquired by the biomarker value acquisition function 352. The value of the biomarker associated with triple negative breast cancer is, for example, a value of an epidermal growth factor receptor (EGFR), an estrogen receptor (ER), a progesterone receptor (PR), or HER2.

More specifically, in a case where the value of the epidermal growth factor receptor is higher than a normal range (in the case of positive), there is a possibility that triple negative breast cancer is present in the subject. Therefore, the biomarker analysis function 355 may select a positive value of the epidermal growth factor receptor as a value of a biomarker associated with triple negative breast cancer. In addition, even in a case where the value of each of the estrogen receptor, the progesterone receptor, and HER2 is in the normal range (in the case of negative), there is a possibility that triple negative breast cancer is present in the subject. Therefore, the biomarker analysis function 355 may select a negative value of each of the estrogen receptor, the progesterone receptor, and HER2 as a value of a biomarker associated with triple negative breast cancer.

In addition, for example, in a case where the property of the drawn object calculated by the image analysis function 354 is that the drawn object is irregularly shaped or has spicules or the like, the biomarker analysis function 355 selects a value of a biomarker associated with luminal A breast cancer from among the values of the biomarker acquired by the biomarker value acquisition function 352. The value of the biomarker associated with luminal A breast cancer is, for example, a value of each of the estrogen receptor, the progesterone receptor, and HER2.

More specifically, in a case where either or both of the estrogen receptor and the progesterone receptor are higher than the normal range (in the case of positive) and the value of HER2 is in the normal range (in the case of negative), there is a possibility that luminal A breast cancer is present in the subject. Therefore, the biomarker analysis function 355 may select values of the estrogen receptor and the progesterone receptor where one or both are positive, and a value of HER2 indicating negative, as the value of the biomarker associated with luminal A breast cancer.

In addition, for example, in a case where the property of the drawn object calculated by the image analysis function 354 is that the drawn object is accompanied by calcification, the biomarker analysis function 355 selects a value of HER2 associated with HER2-positive breast cancer from among the values of the biomarker acquired by the biomarker value acquisition function 352.

More specifically, in a case where the value of HER2 is higher than the normal range (in the case of positive), there is a possibility that HER2-positive breast cancer is present in the subject. Therefore, the biomarker analysis function 355 may select a positive value of HER2 as a value of a biomarker associated with HER2-positive breast cancer.

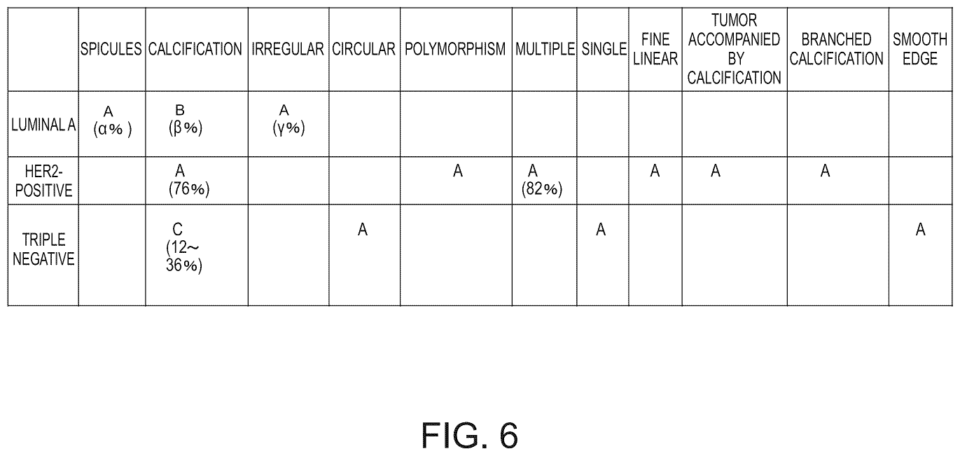

There are a plurality of properties of the drawn object corresponding to one subtype of cancer (see FIG. 6). For example, there are a plurality of properties of the drawn object corresponding to triple negative breast cancer, including a smooth edge of the drawn object (see FIG. 6). In addition, there are a plurality of properties of the drawn object corresponding to luminal A breast cancer, including an irregular shape of the drawn object (see FIG. 6). In addition, there are a plurality of properties of the drawn object corresponding to HER2-positive breast cancer depending on the aspect of calcification (see FIG. 6). The biomarker analysis function 355 selects a biomarker value associated with a corresponding subtype when at least one property among a plurality of properties of the drawn object is calculated for each subtype by the image analysis function 354. For example, the biomarker analysis function 355 selects a biomarker value associated with triple negative breast cancer even in a case where the properties (for example, a circular shape or the like) of another drawn object corresponding to triple negative breast cancer are not calculated when the edge of the drawn object is calculated to be smooth.

Among the biomarker values associated with one subtype are also those of a type common to the other subtypes. For example, as described above, the values of the estrogen receptor, the progesterone receptor, and HER2 associated with triple negative breast cancer are common to luminal A breast cancer and are partially common to HER2-positive breast cancer. In addition, positive or negative values of biomarkers may be partially common among a plurality of subtypes. In addition, there is also a property of a drawn object that is common among the plurality of subtypes (for example, calcification). In addition, when the value of the biomarker associated with the property of the drawn object is selected, a frequency of occurrence of the property of the drawn object is not considered as in the case of determination of consistency described below, and thus it is not known how effective the selected biomarker value is to suspect the presence of the corresponding subtype. Therefore, in a case where the property of the drawn object corresponding to each of the plurality of subtypes is simultaneously calculated by the image analysis function 354, it is difficult to determine which subtype strongly influences the selected biomarker value at the time when the biomarker value associated with the property of the drawn object is selected by the biomarker analysis function 355. This determination can be performed through consistency determination by the determination function 356 and score calculation by the score calculation function 357 to be described below.

In addition, the biomarker analysis function 355 is not limited to the biomarker values acquired by the biomarker value acquisition function 352, and for example, the past medical information of the subject may be further analyzed to select a biomarker value associated with the property of the drawn object calculated by the image analysis function 354. For example, the biomarker analysis function 355 may analyze the past medical information of a subject acquired from an electronic health record (EHR) system, a picture archiving and communication system (PACS), or the like, to select a biomarker value associated with the property of the drawn object. The past medical information of the subject may be, for example, the past examination value, a treatment record of a biopsy using a needle, the past image, or a difference between the past image and the medical information acquired by the image acquisition function 351. The past medical information of the subject is received from the electronic health record system, the picture archiving and communication system, or the like by the communication interface 33 and stored in the memory 34, and then read from the memory 34 by the biomarker analysis function 355 to be used for analysis. Furthermore, instead of or in addition to the past medical information, the current medical information may be analyzed to select biomarker values related to the property of the drawn object calculated by the image analysis function 354.

The determination function 356 determines consistency between the value of the biomarker selected by the biomarker analysis function 355 and the property of the drawn object calculated by the image analysis function 354.

For example, the determination function 356 determines consistency for the subtype corresponding to the selected biomarker value based on whether or not the calculated properties of the drawn object match with each of the plurality of known properties that the drawn object corresponding to the subtype should have, and the frequency of occurrence of the matched properties of the drawn object. For example, it is assumed that the image analysis function 354 calculates that a drawn object is accompanied by spicules, the corresponding subtype is luminal A breast cancer, and the frequency of occurrence of spicules in luminal A breast cancer is defined as A. In this case, the determination function 356 determines that the consistency (that is, the matching degree) between the selected biomarker value associated with luminal A breast cancer (estrogen receptor: negative, progesterone receptor: positive, HER2: negative) and spicules is A. On the other hand, it is assumed that the property that the drawn object corresponding to the luminal A breast cancer should have is accompanied by calcification at occurrence frequency B, but the calcification is not calculated by the image analysis function 354. In this case, the determination function 356 determines that there is no consistency between the selected value of the biomarker associated with luminal A breast cancer and the calcification. The determination function 356 may determine consistency by using a determination table indicating a correspondence relationship among a subtype, a plurality of properties of a drawn object that the subtype should have, and an occurrence frequency of the properties of the drawn object.

The score calculation function 357 calculates a score indicating a possibility that the drawn object is a lesion based on the consistency determined by the determination function 356. For example, in a case where the determination function 356 determines that consistency is high, the score calculation function 357 calculates a high score. On the other hand, in a case where the determination function 356 determines that consistency is low, the score calculation function 357 calculates a low score.

The region-of-interest identification function 358 identifies a highly consistent region of interest from among the plurality of regions of interest determined by the region-of-interest determination function 353.

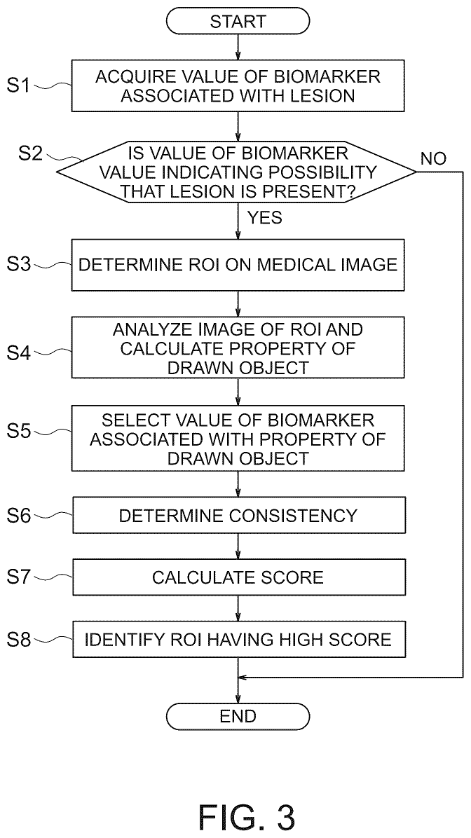

Next, an operation example of the medical information processing apparatus 3 according to the first embodiment configured as described above will be described. FIG. 3 is a flowchart illustrating an operation example of the medical information processing apparatus 3 according to the first embodiment.

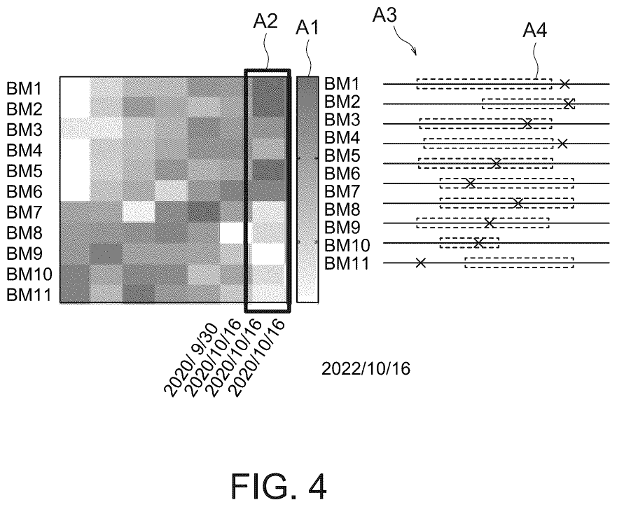

First, as illustrated in FIG. 3, the biomarker value acquisition function 352 acquires a value of a biomarker associated with a lesion (Step S1). For example, when an input operation for selecting a subject by an operator is received by the input interface 31, the biomarker value acquisition function 352 reads and acquires a biomarker value for the selected subject from the memory 34. FIG. 4 is a view illustrating an example of a biomarker value. The biomarker value acquisition function 352 may display the acquired biomarker value via the output interface 32. In FIG. 4, the biomarker values for each time series of a plurality of types of biomarkers BM1 to BM11 are illustrated as rectangular images. A density of the rectangular image is higher as the value of the biomarker is larger. The reference sign A1 in FIG. 4 is an indicator indicating the density (that is, the value of the biomarker) of the rectangular images. The reference sign A2 is a current value of a biomarker. The reference sign A3 denotes an image indicating whether or not the current value of the biomarker indicated by the symbol “×” is within the normal range indicated by the broken-line frame A4.

After the value of the biomarker associated with the pathology is acquired, as illustrated in FIG. 3, the image acquisition function 351 determines whether or not the value of the biomarker is a value indicating a possibility that a lesion is present in the subject (Step S2). For example, in a case where a positive value of an epidermal growth factor receptor or a negative value of an estrogen receptor, a progesterone receptor, or HER2 is acquired, the image acquisition function 351 determines that there is a possibility that triple negative breast cancer is present in the subject. In addition, for example, in a case where either or both of positive values of the estrogen receptor and the progesterone receptor and a negative value of HER2 are acquired, the image acquisition function 351 determines that there is a possibility that luminal A breast cancer is present in the subject. In addition, for example, in a case where a positive value of HER2 is acquired, the image acquisition function 351 determines that there is a possibility that HER2-positive breast cancer is present in the subject.

In a case where the value of the biomarker is a value indicating that there is a possibility that a lesion is present in the subject (Step S2: YES), the image acquisition function 351 reads and acquires a medical image for the subject from the memory 34. Then, the region-of-interest determination function 353 determines the region of interest (ROI) on the medical image acquired by the image acquisition function 351 (Step S3). On the other hand, in a case where the value of the biomarker is not a value indicating that there is a possibility that a lesion is present in the subject (Step S2: NO), the processing is terminated.

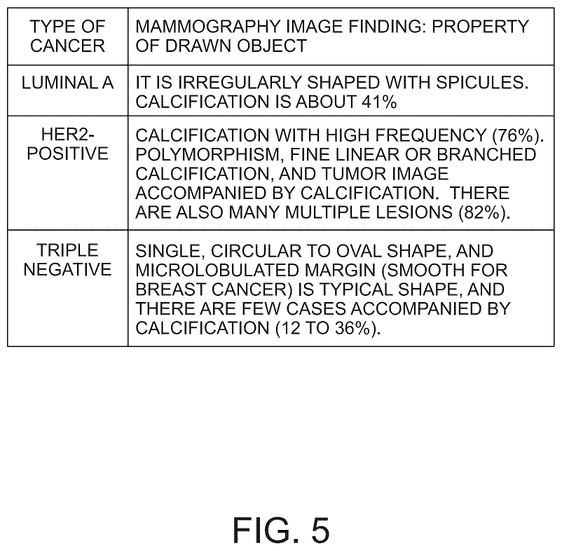

After the ROI is determined, the image analysis function 354 analyzes the image of the ROI and calculates the property of the drawn object (Step S4). FIG. 5 is a view illustrating a correspondence relationship between a type of cancer and a mammography image finding in the operation example of the medical information processing apparatus 3 according to the first embodiment. There is a correspondence relationship between the type of cancer and the property of the drawn object as illustrated in FIG. 5. For example, a drawn object showing triple negative breast cancer has a plurality of properties such as a circular, single, and microlobulated margin (smooth for breast cancer), and infrequent calcification. In addition, for example, a drawn object showing luminal A breast cancer has a plurality of properties such as an irregular shape, spicules, and moderately frequent calcification. In addition, for example, a drawn object showing HER2-positive breast cancer has a plurality of properties associated with polymorphism, fine linear or branched calcification, and calcified tumors.

After the property of the drawn object is calculated, as illustrated in FIG. 3, the biomarker analysis function 355 selects a value of a biomarker associated with the property of the drawn object (Step S5). For example, the biomarker analysis function 355 calculates a value of a biomarker corresponding to a lesion having the property of the drawn object calculated by the image analysis function 354.

Next, the determination function 356 determines consistency between the selected value of the biomarker and the property of the drawn object (Step S6).

FIG. 6 is a view illustrating an example of a value of a determination table used for determining consistency in the operation example of the medical information processing apparatus 3 according to the first embodiment. In the example illustrated in FIG. 6, the determination function 356 determines consistency by using a determination table indicating a correspondence relationship between the type of the subtype corresponding to the value of the biomarker selected by the biomarker analysis function 355 and a plurality of properties of the drawn object included in the subtype.

More specifically, in the determination table illustrated in FIG. 6, luminal A breast cancer, HER2-positive breast cancer, and triple negative breast cancer are described as the types of subtypes. In addition, in the determination table illustrated in FIG. 6, the occurrence frequency of each of the plurality of properties of the drawn object is indicated by values of A to C. A indicates that the property of the drawn object corresponding to the subtype occurs frequently. B indicates that the property of the drawn object corresponding to the subtype occurs moderately frequently. C indicates that the property of the drawn object corresponding to the subtype occurs with low frequency. Properties of a drawn object that are not described in any of A, B, and C mean that they do not occur in the corresponding subtype. Note that, for convenience of explaining calculation of a score to be described below, numerical values (such as α%) indicating specific occurrence frequencies are also written in some occurrence frequencies A to C. The HER2-positive calcification: 76% and the calcification of triple negative breast cancer: 12 to 36% illustrated in FIG. 6 correspond to the occurrence frequency of calcification in the mammography image findings illustrated in FIG. 5.

For example, it is assumed that a biomarker value associated with luminal A breast cancer (estrogen receptor: negative, progesterone receptor: positive, HER2: negative) and a biomarker value associated with triple negative breast cancer (epidermal growth factor receptor: positive, estrogen receptor: negative, HER2: negative) are selected. In addition, it is assumed that the properties of the drawn object are calculated to include spicules, be irregularly shaped, and have a smooth edge. In this case, according to the determination table of FIG. 6, for luminal A breast cancer, two properties (specula and irregular) after three properties (spicules, calcification, and irregular) that the drawn object should have are calculated. That is, for luminal A breast cancer, two items of consistency are satisfied. On the other hand, for triple negative breast cancer, only one property (smooth edge) among four properties (calcification, circular, single, smooth margin) that the drawn object should have is calculated. That is, for triple negative breast cancer, one item of consistency is satisfied. In this case, the determination function 356 determines that consistency for luminal A breast cancer is higher than consistency for triple negative breast cancer.

After the consistency is determined, as illustrated in FIG. 3, the score calculation function 357 calculates a score indicating a possibility that the drawn object is a lesion based on the determined consistency (Step S7). The score calculation function 357 causes the output interface 32 to output the calculated score. For example, for luminal A breast cancer, in a case where spicules and an irregular shape are calculated by the image analysis function 354 and calcification is not calculated, the score calculation function 357 calculates a score for luminal A breast cancer according to the following equation.

$$Score = α \times ( 1 - β ) \times γ \qquad ( 1 )$$

α is a specific occurrence frequency (that is, consistency) of the spicules calculated by the image analysis function 354. γ is a specific occurrence frequency (that is, consistency) of the irregular shape calculated by the image analysis function 354. β is a specific occurrence frequency of calcification. However, since calcification is not calculated by the image analysis function 354 and there is no consistency, (1−β) is used to calculate the score. 1−β is a value smaller than β, and functions to reduce the score. Note that the score may be converted into a simpler numerical value and output after being calculated according to Equation (1). Here, the parameters α, β, and γ indicating the occurrence frequency are calculated as values of 0.5 or more. For example, in a case where the frequency of “there is calcification” is 0.4, the score is calculated using the frequency of 0.6 “there is no calcification” as a parameter.

The score of the subtype other than luminal A breast cancer is also obtained as a product of the occurrence frequency of the property of the drawn object calculated by the image analysis function 354 and a value obtained by subtracting the occurrence frequency of the property of the drawn object not calculated by the image analysis function 354 from 1. As a result, it is possible to calculate a score having a magnitude corresponding to the consistency.

After the score is calculated, in a case where a plurality of ROIs are determined by the region-of-interest determination function 353, the region-of-interest identification function 358 identifies an ROI having a high score from among the plurality of ROIs (Step S8). The region-of-interest identification function 358 causes the output interface 32 to output the identified ROI with a high score.

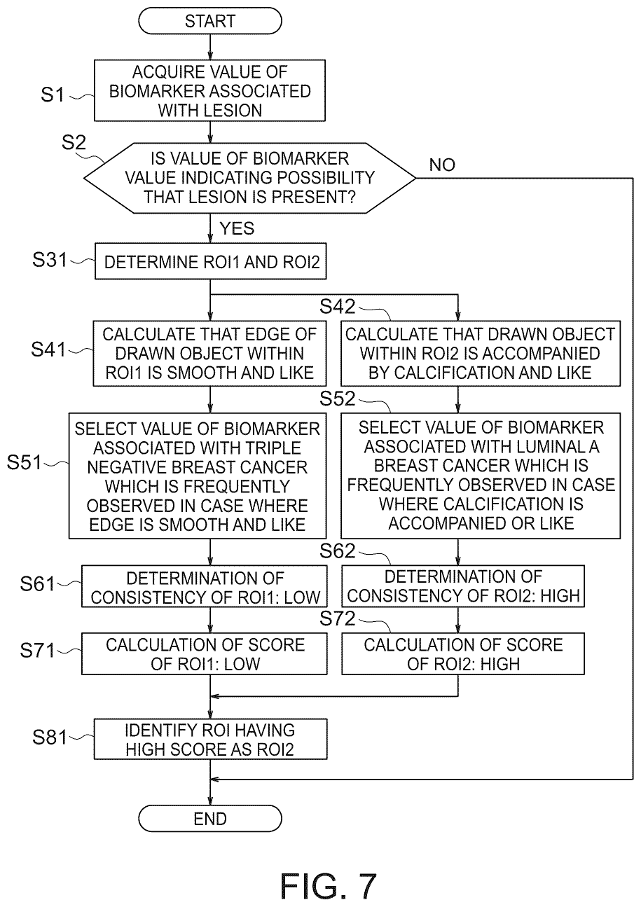

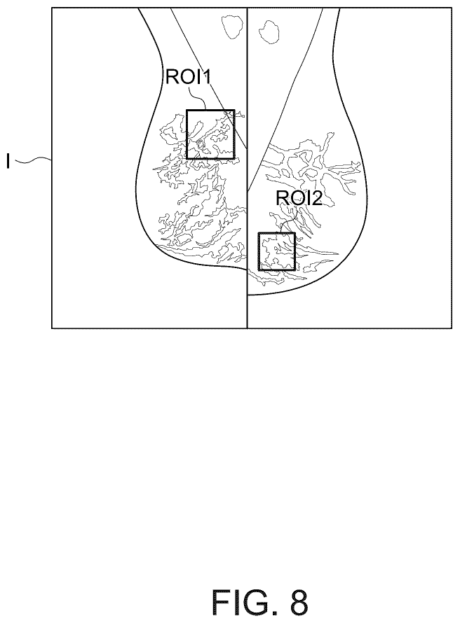

FIG. 7 is a flowchart illustrating a detailed operation example of the medical information processing apparatus 3 according to the first embodiment. FIG. 8 is a view illustrating a mammography image and a region of interest in the operation example of the medical information processing apparatus 3 according to the first embodiment. FIGS. 7 and 8 illustrate detailed examples of some steps of the flowchart of FIG. 3.

Specifically, in the examples illustrated in FIGS. 7 and 8, the region-of-interest determination function 353 determines ROI1 and ROI2 on the mammography image I (Step S31). In the example illustrated in FIG. 8, ROI1 and ROI2 are determined on the right and left breasts, respectively.

In addition, in the examples illustrated in FIGS. 7 and 8, the image analysis function 354 calculates that the edge of the drawn object is smooth as the property of the drawn object in the ROI1 (Step S41). In addition, the image analysis function 354 calculates that the drawn object is accompanied by calcification as a property of the drawn object in ROI2 (Step S42).

In addition, in the examples illustrated in FIGS. 7 and 8, the biomarker analysis function 355 selects, for ROI1, a value of a biomarker associated with triple negative breast cancer (for example, epidermal growth factor receptor: positive, estrogen receptor: negative, HER2: negative), which is frequently observed in a case where the edge of the drawn object is smooth (Step S51). In addition, the biomarker analysis function 355 selects, for ROI2, values of a biomarker associated with luminal A breast cancer (for example, estrogen receptor: negative, progesterone receptor: positive, HER2: negative), which is frequently observed in a case where the drawn object is accompanied by calcification (Step S52).

In addition, in the examples illustrated in FIGS. 7 and 8, the determination function 356 determines that the consistency for the ROI1 is low based on the small number of properties of the drawn object corresponding to the triple negative breast cancer calculated by the image analysis function 354 (Step S61). On the other hand, the determination function 356 determines that the consistency for the ROI2 is high based on the large number of properties of the drawn object corresponding to the luminal A breast cancer calculated by the image analysis function 354 (Step S62).

In addition, in the examples illustrated in FIGS. 7 and 8, the score calculation function 357 calculates a score having a low value for the ROI1 based on the determination that the consistency for ROI1 is low (Step S71). On the other hand, the score calculation function 357 calculates a score having a high value for the ROI2 based on the determination that the consistency for ROI2 is high (Step S72).

In addition, in the examples illustrated in FIGS. 7 and 8, the region-of-interest identification function 358 identifies a region of interest having a high score as ROI2 (Step S81). Furthermore, in this case, the determination function 356 may estimate information about the subject based at least on the region of interest (ROI2) with the highest score and output the estimation result to the output interface 32. This estimation may be based on the property of the drawn object calculated in step S4 for the identified region of interest, or it may be performed by inputting the biomarker values and the images of the identified region of interest into a machine learning model.

As described above, in the first embodiment, the image acquisition function 351 acquires a medical image obtained by imaging a subject. In addition, the biomarker value acquisition function 352 acquires a value of a biomarker contained in a sample collected from a subject. In addition, the region-of-interest determination function 353 determines a region of interest on the medical image acquired by the image acquisition function 351. The image analysis function 354 analyzes the image of the region of interest determined by the region-of-interest determination function 353 and calculates a property of a drawn object. The biomarker analysis function 355 selects a value of a biomarker associated with the property of the drawn object calculated by the image analysis function 354. The determination function 356 determines consistency between the value of the biomarker selected by the biomarker analysis function 355 and the property of the drawn object calculated by the image analysis function 354.

As a result, it is possible to efficiently determine the consistency by selecting the value of the biomarker associated with the property of the drawn object in the region of interest. In addition, it is possible to determine the presence or absence and the position of the lesion with high accuracy based on the consistency between the selected value of the biomarker and the property of the drawn object. Therefore, according to the first embodiment, the lesion determination accuracy can be improved.

In addition, in the first embodiment, the biomarker value acquisition function 352 acquires a value of a biomarker associated with a lesion that is potentially present in the subject, and the image analysis function 354 calculates the property of the drawn object according to the type of the lesion.

As a result, the presence or absence and the location of the lesion can be determined with higher accuracy based on the consistency between the value of biomarker associated with the lesion and the properties of the drawn object depending on the type of the lesion. Therefore, the lesion determination accuracy can be further improved.

In addition, in the first embodiment, the region-of-interest determination function 353 can determine a plurality of regions of interest on the medical image acquired by the image acquisition function 351. The region-of-interest identification function 358 identifies a highly consistent region of interest from among the plurality of regions of interest determined by the region-of-interest determination function 353.

As a result, in a case where a plurality of regions of interest are determined, it is possible to easily determine which region of interest is to be subjected to a needle biopsy (cytology or tissue diagnosis).

In addition, in the first embodiment, the biomarker analysis function 355 further analyzes the past medical information and selects the value of the biomarker associated with the property of the drawn object calculated by the image analysis function 354.

As a result, since the consistency can be determined with higher accuracy further based on the past medical information of the subject, the lesion determination accuracy can be further improved.

In addition, in the first embodiment, the score calculation function 357 calculates a score indicating a possibility that the drawn object is a lesion based on the consistency determined by the determination function 356.

As a result, it is possible to easily determine the possibility that a corresponding lesion is present based on the score.

In addition, in the first embodiment, in a case where the value of the biomarker acquired by the biomarker value acquisition function 352 is a value indicating the possibility that a lesion is present in the subject, a region-of-interest determination function 353 determines a region of interest, and the image analysis function 354 calculates the properties of the drawn object.

As a result, when the location of a lesion cannot be determined only from the biomarker value, it is possible to determine the location of the lesion based on the consistency between the biomarker value and the properties of the drawn object.

### First Modification of First Embodiment

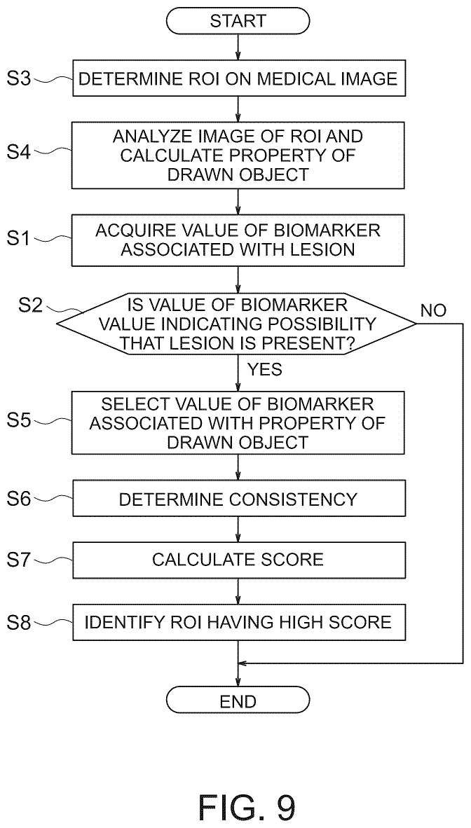

Next, a first modification of the first embodiment in which a value of a biomarker is acquired after an ROI is determined will be described focusing on a difference from the above-described embodiment. FIG. 9 is a flowchart illustrating an operation of a medical information processing apparatus 3 according to the first modification of the first embodiment.

In the example illustrated in FIG. 9, first, the region-of-interest determination function 353 determines an ROI on a medical image (Step S3). For example, when an input operation for selecting a subject by an operator is received by the input interface 31, the image acquisition function 351 reads and acquires a biomarker value for the selected subject from the memory 34. Then, the region-of-interest determination function 353 determines the ROI on the medical image acquired by the image acquisition function 351 (Step S3).

After the ROI is determined, the image analysis function 354 analyzes the image of the ROI and calculates the property of the drawn object (Step S4).

After the properties of the drawn object are calculated, the biomarker value acquisition function 352 acquires a value of a biomarker associated with a lesion (Step S1). For example, the biomarker value acquisition function 352 reads and acquires the value of the biomarker for the selected subject from the memory 34.

After the value of the biomarker associated with the pathology is acquired, the biomarker analysis function 355 determines whether or not the acquired value of the biomarker is a value indicating a possibility that a lesion is present in the subject (Step S2).

In a case where the value of the biomarker is a value indicating the possibility that a lesion is present in the subject (Step S2: YES), the biomarker analysis function 355 selects the value of the biomarker associated with the property of the drawn object (Step S5). Thereafter, similarly to FIG. 3, the processing after Step S6 is performed. On the other hand, in a case where the value of the biomarker is not a value indicating that there is a possibility that a lesion is present in the subject (Step S2: NO), the processing is terminated.

Also, in the example illustrated in FIG. 9, similarly to the above-described embodiment, the presence or absence and the position of the lesion can be determined with high accuracy based on the consistency between the value of the biomarker and the property of the drawn object, and the determination accuracy of the lesion can be improved.

### Second Modification of First Embodiment

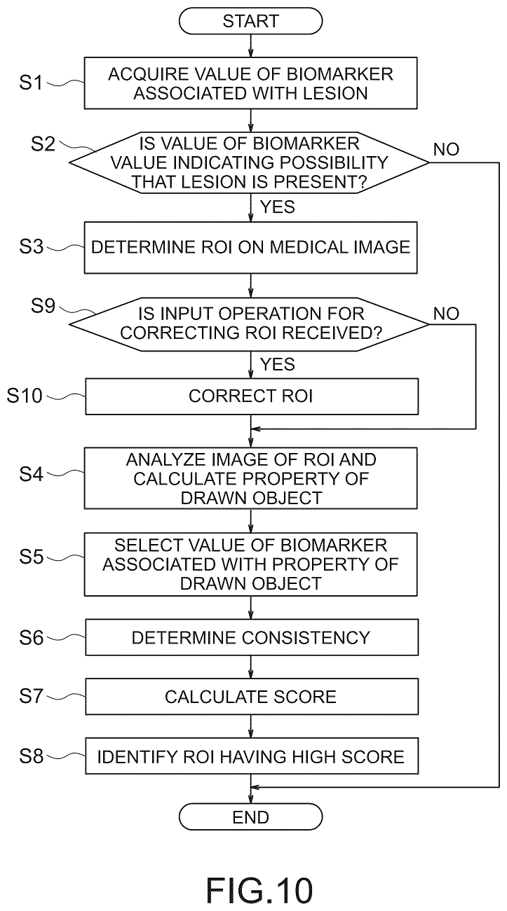

Next, a second modification of the first embodiment in which an ROI is modified in accordance with an input operation will be described focusing on a difference from the above-described embodiment. FIG. 10 is a flowchart illustrating an operation of a medical information processing apparatus 3 according to a second modification of the first embodiment.

In the example illustrated in FIG. 10, after determining the ROI (Step S3), the region-of-interest determination function 353 determines whether an input operation for correcting the ROI is received by the input interface 31 (Step S9). For example, when an operator performs an input operation for selecting a subject on a screen for selecting the subject displayed by the output interface 32, the region-of-interest determination function 353 reads a mammography image of the selected subject from the memory 34 and displays the read image on the screen. Then, the region-of-interest determination function 353 automatically determines an ROI suspected of being a lesion by using machine learning for the mammography image displayed on the screen. The determined ROI is displayed as an enlarged image. In addition, the determined ROI is displayed in a manually correctable manner.

In a case where an input operation for correcting the ROI is received (Step S9: YES), the region-of-interest determination function 353 corrects the ROI according to the input operation (Step S10). After the ROI is corrected, or in a case where the input operation for correcting the ROI is not received (Step S9: NO), the processing after Step S4 is performed. Note that, in Step S9, in addition to or instead of the input operation for correcting the ROI, setting of a new ROI may be received from the operator.

According to the example illustrated in FIG. 10, since the ROI can be corrected, convenience can be improved.

### Third Modification of First Embodiment

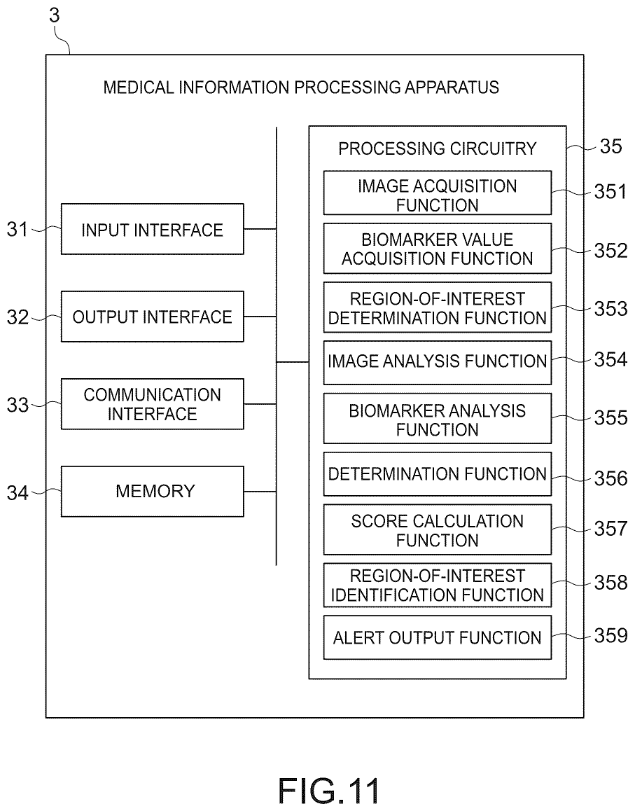

Next, a third modification of the first embodiment in which an alert is output in a case where a score is low will be described focusing on a difference from the above-described embodiment. FIG. 11 is a block diagram illustrating a configuration of a medical information processing apparatus 3 according to the third modification of the first embodiment.

In the example illustrated in FIG. 11, a processing circuitry 35 of the medical information processing apparatus 3 further includes an alert output function 359 in addition to the configuration of FIG. 2. The alert output function 359 is an example of an alert output unit. In a case where the score calculated by the score calculation function 357 is less than a threshold value, the alert output function 359 outputs, via an output interface 32, an alert notifying of the possibility that a lesion is present at a site other than the region of interest.

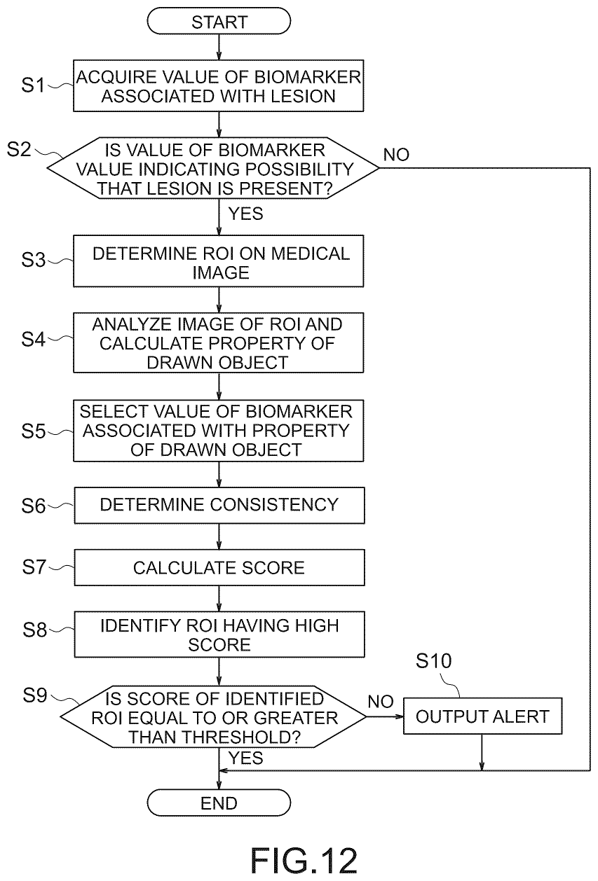

FIG. 12 is a flowchart illustrating an operation example of the medical information processing apparatus 3 according to the third modification of the first embodiment. In the example illustrated in FIG. 12, after the ROI having a high score is identified by the region-of-interest identification function 358, the alert output function 359 determines whether the score of the identified ROI is equal to or greater than the threshold (Step S9).

In a case where the score of the identified ROI is not equal to or greater than the threshold (Step S9: NO), the alert output function 359 outputs an alert (Step S10). On the other hand, in a case where the score of the identified ROI is equal to or greater than the threshold (Step S9: YES), the processing is terminated.

According to the examples illustrated in FIGS. 11 and 12, it is possible to further improve the lesion determination accuracy by outputting an alert notifying of the possibility that a lesion is present at a site other than the region of interest.

### Second Embodiment

Next, a second embodiment for improving the determination accuracy of a drawn object not associated with a lesion will be described focusing on a difference from the above-described embodiment.

In the second embodiment, in a case where the value of the biomarker acquired by the biomarker value acquisition function 352 is not a value indicating a possibility that a lesion is present in the subject, the biomarker analysis function 355 selects a value of a biomarker that is not associated with a lesion that is potentially present in the subject. The determination function 356 determines the consistency between the biomarker value and the property of the drawn object based on the value of the biomarker not associated with the lesion selected by the biomarker analysis function 355.

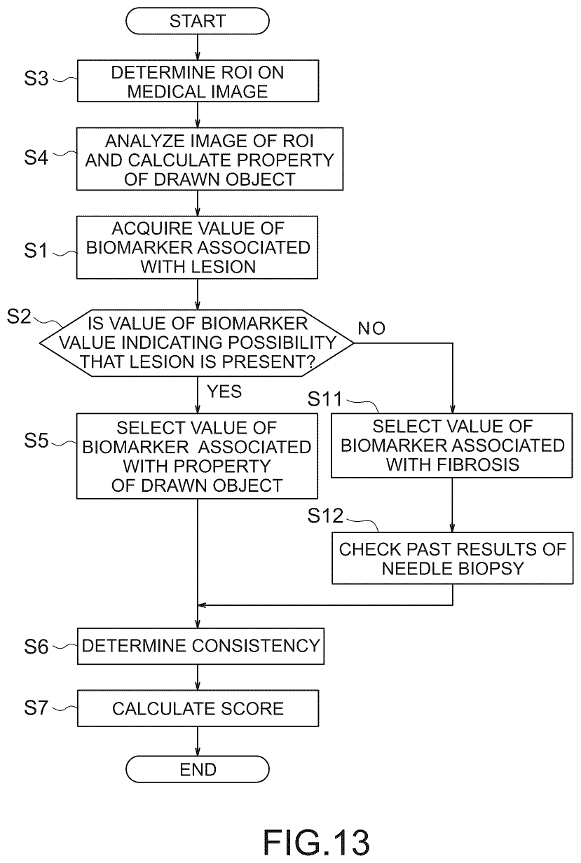

FIG. 13 is a flowchart illustrating an operation example of a medical information processing apparatus 3 according to the second embodiment. In the example illustrated in FIG. 13, the region-of-interest determination function 353 determines an ROI on a medical image (Step S3).

After the ROI is determined, the image analysis function 354 analyzes the image of the ROI and calculates the property of the drawn object (Step S4).

After the properties of the drawn object are calculated, the image acquisition function 351 acquires a value of a biomarker associated with a lesion (Step S1). For example, the image acquisition function 351 reads and acquires the value of the biomarker for the selected subject from the memory 34.

After the value of the biomarker associated with the pathology is acquired, the biomarker analysis function 355 determines whether or not the acquired value of the biomarker is a value indicating a possibility that a lesion is present in the subject (Step S2).

In a case where the value of the biomarker is a value indicating the possibility that a lesion is present in the subject (Step S2: YES), the biomarker analysis function 355 selects the value of the biomarker associated with the property of the drawn object (Step S5). After the value of the biomarker associated with the property of the drawn object is selected, similarly to FIG. 3, the processing after Step S6 is performed.

On the other hand, in case where the value of the biomarker is not a value indicating a possibility that a lesion is present in the subject (Step S2: NO), the biomarker analysis function 355 selects a value of a biomarker associated with fibrosis as a value of a biomarker not associated with a lesion that is potentially present in the subject (Step S11).

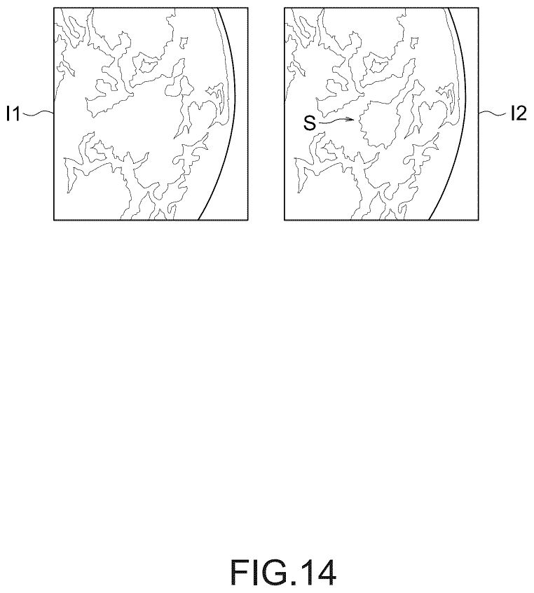

FIG. 14 is a view illustrating a mammography image before a biopsy and a mammography image after a biopsy in the operation example of the medical information processing apparatus 3 according to the second embodiment. For example, as illustrated in FIG. 14, suspicious microcalcifications are found in the mammography image I1 before a needle biopsy, but after it is determined that epithelial hyperplasia is formed by the needle biopsy without dysplasia, formation of a significant scar S may be confirmed in a mammography image I2 obtained by follow-up mammography after 12 months. The value of the biomarker associated with fibrosis is, for example, a value of a biomarker associated with such a scar S.

In addition, as illustrated in FIG. 13, the determination function 356 checks the past results of needle biopsy of the subject (Step S12). For example, the determination function 356 reads, from the memory 34, the past medical information of the subject acquired from the electronic health record system, the picture archiving and communication system, or the like and stored in the memory 34. Then, the determination function 356 confirms the presence or absence of a needle biopsy and the site based on the read history of past needle biopsies of the subject.

After checking the past needle biopsy results of the subject, the determination function 356 determines consistency between the value of the biomarker selected by the biomarker analysis function 355 and the property of the drawn object based on the value of the biomarker associated with fibrosis and the past needle biopsy results of the subject. For example, in case where a biomarker value associated with fibrosis is selected and a drawn object in an ROI is determined to be a scar from the past needle biopsies, the determination function 356 determines that consistency for fibrosis is high. In the calculation of the score by the score calculation function 357, fibrosis is used as a low value parameter. Therefore, the score in the case of fibrosis is less than the score in the case of the subtype.

Even in a case where it is determined to be benign after a needle biopsy of breast cancer, it may be difficult to determine whether it is breast cancer or a scar due to needle biopsy in case where new findings appear by subsequent follow-up mammography. According to the second embodiment, it is possible to suppress the false positive determination by performing the determination of non-lesion based on the value of the biomarker not associated with a lesion with high accuracy. As a result, it is possible to improve the easiness of lesion determination.

### Modification of Second Embodiment

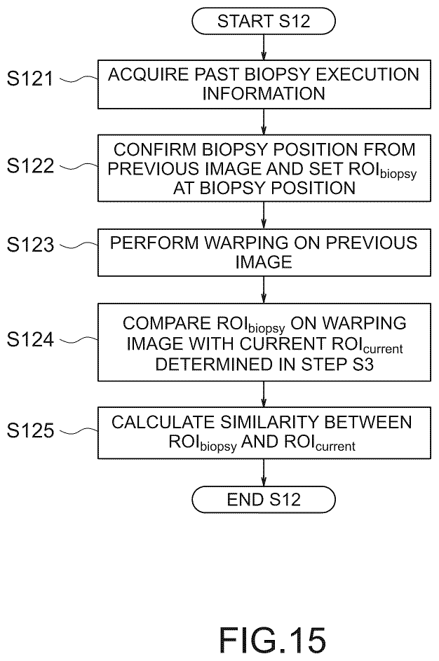

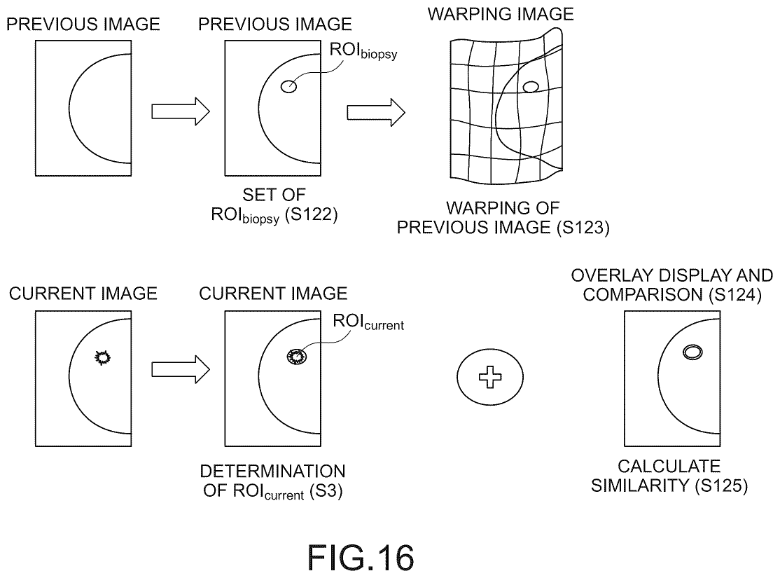

Next, a modification of the second embodiment will be described focusing on a difference from the above-described embodiment. FIG. 15 is a flowchart illustrating an operation example of a medical information processing apparatus 3 according to a modification of the second embodiment. FIG. 16 is a schematic view illustrating an operation example of the medical information processing apparatus 3 according to the modification of the second embodiment.

In the examples illustrated in FIGS. 15 and 16, the past needle biopsy results of the subject are checked (Step S12) as follows.

First, the determination function 356 reads and acquires, from the memory 34, biopsy execution information of past needle biopsies obtained from the electronic health record system, the picture archiving and communication system, or the like and stored in the memory 34 (Step S121).

After acquiring the past biopsy execution information, the determination function 356 confirms the past biopsy position from the previous image that is one of the past medical information of the subject. Then, the determination function 356 sets ROI_{biopsy} at the confirmed biopsy position (Step S122).

After setting the ROI_{biopsy}, the determination function 356 generates a warping image by performing warping processing on the previous image in consideration of the degree of deformation of the current image with respect to the previous image (Step S123).

After generating the warping image, the determination function 356 compares ROI_{biopsy} on the warping image with ROI_{current} on the current image determined in Step S3 (Step S124). In the example illustrated in FIG. 16, the determination function 356 displays the current image and the warping image in an overlay manner, and compares ROI_{biopsy} with ROI_{current}.

After comparing the ROI_{biopsy} on the warping image with the ROI_{current} on the current image, the determination function 356 calculates a similarity between the ROI_{biopsy} on the warping image and the ROI_{current} on the current image based on the determination result (Step S125). The similarity may be, for example, a Dice coefficient. In a case where the calculated similarity is equal to or greater than the threshold value, the determination function 356 determines that the drawn object is a scar by a needle biopsy.

According to the modification of the second embodiment, warping the current image in consideration of the degree of deformation of the current image with respect to the past image can improve the accuracy of scar determination.

Note that the term “processor” used in the above description means, for example, a central processing unit (CPU), a graphics processing unit (GPU), or a circuit such as an application specific integrated circuit (ASIC) or a programmable logic device (for example, a simple programmable logic device (SPLD), a complex programmable logic device (CPLD), or a field programmable gate array (FPGA)). The processor realizes the function by reading and executing the program stored in the storage circuit. Note that, instead of storing the program in the storage circuit, the program may be directly incorporated in the circuit of the processor. In this case, the processor realizes the function by reading and executing the program incorporated into the circuit. Note that the processor is not limited to a case of being configured as a single processor circuit, and a plurality of independent circuits may be combined to be configured as one processor to realize the function. Furthermore, a plurality of components in FIG. 2 may be integrated into one processor to realize the function.

In the first and second embodiments and their modifications, the processing circuitry 35 select a value of a biomarker associated with the calculated property of the drawn object (the biomarker analysis function 355) and determine consistency between the selected value of the biomarker and the calculated property of the drawn object (the determination function 356). However, the biomarker analysis function may be omitted. In this case, the processing circuitry determine consistency between the calculated property of the drawn object and all of or part (not dependent upon of the calculated property of the drawn object) of the biomarker values. For example, the processing circuitry 35 may select a function for calculating consistency from biomarker values in accordance with the calculated property of the drawn object, and input the biomarker values to the function so as to determine the consistency.

In the configuration described above and the first and second embodiments and their modifications, is disclosed a medical information processing apparatus comprising: processing circuitry configured to acquire a medical image obtained by imaging a subject, acquire one or more values of one or more biomarkers contained in a sample collected from the subject, determine a region of interest on the acquired medical image, analyze the image of the determined region of interest and calculate a property of a drawn object, and determine consistency between the calculated property of the drawn object and all or part of the acquired one or more values.

According to at least one embodiment described above, the lesion determination accuracy can be improved.

Although several embodiments have been described above, these embodiments have been presented only as examples, and are not intended to limit the scope of the invention. The novel apparatuses and methods described in the present specification can be implemented in various other forms. In addition, various omissions, substitutions, and changes can be made to the forms of the apparatus and the method described in the present specification without departing from the gist of the invention. The appended claims and their equivalents are intended to include such forms and modifications as fall within the scope and spirit of the invention.

Reference Signs List

What is claimed is:

1. A medical information processing apparatus comprising:
processing circuitry configured to
acquire a medical image obtained by imaging a subject,
acquire a value of a biomarker contained in a sample collected from the subject,
determine a region of interest on the acquired medical image,
analyze the image of the determined region of interest and calculate a property of a drawn object,
select a value of a biomarker associated with the calculated property of the drawn object, and
determine consistency between the selected value of the biomarker and the calculated property of the drawn object.

2. The medical information processing apparatus according to claim 1, wherein
the processing circuitry is further configured to
acquire a value of a biomarker associated with a lesion that is potentially present in the subject, and
calculate the property of the drawn object according to a type of the lesion.

3. The medical information processing apparatus according to claim 1, wherein
the processing circuitry is further configured to
be capable of determining a plurality of regions of interest on the acquired medical image, and
identify a region of interest having high consistency among the plurality of determined regions of interest.

4. The medical information processing apparatus according to claim 1, wherein the processing circuitry is further configured to analyze past medical information to select a value of a biomarker associated with the property of the drawn object.

5. The medical information processing apparatus according to claim 1, wherein the processing circuitry is further configured to calculate a score indicating a possibility that the drawn object is the lesion based on the determined consistency.

6. The medical information processing apparatus according to claim 5, wherein the processing circuitry is further configured to output an alert in a case where the calculated score is less than a threshold.

7. The medical information processing apparatus according to claim 1, wherein the processing circuitry is further configured to, in a case where the acquired value of the biomarker is a value indicating a possibility that a lesion is present in the subject, determine the region of interest, and calculate the property of the drawn object.

8. The medical information processing apparatus according to claim 1, wherein the processing circuitry is further configured to, after the region of interest is determined, select a value of a biomarker associated with the property of the drawn object.

9. The medical information processing apparatus according to claim 8, wherein the processing circuitry is further configured to, after the region of interest is determined, in a case where the acquired value of the biomarker is a value indicating a possibility that a lesion is present in the subject, select a value of a biomarker associated with the property of the drawn object.

10. The medical information processing apparatus according to claim 9, wherein
the processing circuitry is further configured to,
in a case where the acquired value of the biomarker is not a value indicating a possibility that a lesion is present in the subject, select a value of a biomarker not associated with the lesion that is potentially present in the subject, and
determine the consistency based on the value of the biomarker not associated with the selected lesion.

11. The medical information processing apparatus according to claim 10, wherein the value of the biomarker not associated with the lesion includes a value of a biomarker associated with fibrosis.

12. The medical information processing apparatus according to claim 1, wherein the processing circuitry is further configured to determine the region of interest based on machine learning.

13. The medical information processing apparatus according to claim 12, further comprising an input interface that receives an input operation for correcting the determined region of interest.

14. The medical information processing apparatus according to claim 1, wherein the sample collected from the subject is a body fluid of the subject.

15. The medical information processing apparatus according to claim 1, wherein the processing circuitry is further configured to
acquire values of a plurality of types of biomarkers, andselect a plurality of values of biomarkers from the plurality of types of biomarkers for which the values were obtained.

16. The medical information processing apparatus according to claim 3, wherein the processing circuitry is further configured to output a result of estimation of information on a state of the subject based on the identified region of interest.

17. A non-transitory computer-readable storage medium recording a program, the program causing a computer to execute:
a process of acquiring a medical image obtained by imaging a subject;
a process of acquiring a value of a biomarker contained in a sample collected from the subject;
a process of determining a region of interest on the acquired medical image;
a process of analyzing an image of the determined region of interest and calculating a property of a drawn object;
a process of selecting a value of a biomarker associated with the calculated property of the drawn object; and
a process of determining consistency between the selected value of the biomarker and the calculated property of the drawn object.
